(19) United States
(12) Patent Application Publication
(10) Pub. No.: US 2025/0117343 A1
(43) Pub. Date: Apr. 10, 2025

(54) PASSING SENSING INFORMATION IN A MEMORY STACK THROUGH A PROXY DIE

(71) Applicant: Intel Corporation, Santa Clara, CA (US)

(72) Inventors: Saravanan SETHURAMAN, Portland, OR (US); George VERGIS, Portland, OR (US)

(21) Appl. No.: 18/990,908

(22) Filed: Dec. 20, 2024

Related U.S. Application Data
(60) Provisional application No. 63/686,804, filed on Aug. 25, 2024.

(51) Int. Cl. G06F 13/16

(52) U.S. Cl. CPC G06F 13/1668; G06F 2213/16

(57) ABSTRACT

A system includes a memory die stack that provides sensing information via proxy. The memory die stack includes at least a first memory die with a sensor that generates sensing data for the first memory die and a second memory die with a sensor that generates sensing data for the second memory die. The proxy is a logic device that aggregates and sends the sensing data for both memory dies over a management communication bus.

### CLAIM OF PRIORITY

This application claims the benefit of priority to U.S. Provisional Application No. 63/686,804, filed Aug. 25, 2024. The entire contents of that application are incorporated by reference.

### FIELD

Descriptions are generally related to memory systems, and more particular descriptions are related to passing memory subsystem sensing information through a proxy.

### BACKGROUND

The demand for computing power for AI (artificial intelligence) applications continues to increase. AI systems typically have high power demands, not just for the computing operations, but for the memory bandwidth, transferring data between the memory and the processors. Refresh is a mechanism used to reduce memory power use. The frequency of refresh is influenced by the temperature sensing of the memory.

There is typically one temperature sensor for a group of memory devices, for example, a TSOD (thermal sensor on DIMM (dual inline memory module)). The granularity of temperature measurement is on the order of 5C. Thus, the temperature sensing in the memory subsystem is relatively coarse-grained when considering the difference in temperature that can occur from one memory device to another on a memory module.

While “TSOD” specifically has “DIMM” in its official naming, TSOD is used to refer to a thermal sensor (or temperature sensor) on a memory module. There are common memory modules other than DIMMs, such as a CAMM (compression attached memory module). As used herein, TSOD can refer to a thermal sensor on a memory module. There is consideration for two TSODs on a memory module. However, increasing the number of TSODs not only increases the BOM (bill of material) cost, it also increases the amount of board space needed for sensing components. Another significant cost to increasing the number of sensors is that it would increase the number of signal lines used between the memory module and the host.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a system that passes memory sensor information through proxy.

FIG. 2 is a block diagram of an example of a memory module for passing information by proxy.

FIG. 3 is a block diagram of an example of a memory module with data buffers for passing information by proxy.

FIG. 4 is a block diagram of an example of a memory stack that extends sensor function through information passing by proxy.

FIGS. 5A-5B are block diagrams of examples of an offset memory stack.

FIG. 6 is a flow diagram of an example of a process for providing sensing information by proxy.

FIG. 7 is a block diagram of an example of a memory subsystem in which passing sensing information by proxy can be implemented.

FIGS. 8A-8B are block diagrams of an example of a CAMM system in which passing sensing information by proxy can be implemented.

FIG. 9 is a block diagram of an example of a computing system in which passing sensing information by proxy can be implemented.

FIG. 10 is a block diagram of an example of a multi-node network in which passing sensing information by proxy can be implemented.

Descriptions of certain details and implementations follow, including non-limiting descriptions of the figures, which may depict some or all examples, and well as other potential implementations.

### DETAILED DESCRIPTION

As described herein, a system provides the ability to pass sensing information from the memory module to the host via a proxy. Thus, there can be more sensors to provide information with finer granularity, and that information can be passed to the host without increasing the number of signal lines used for communicating the sensing data.

A specific implementation provides a proxy die for sensing data. In one specific implementation, the sensing data is temperature sensing data. While temperature sensing/thermal sensing is used in many of the examples below, it will be understood that additional sensing information can be communicated via proxy in a similar manner to what is described.

With the increased demand for AI (artificial intelligence), there are efforts made to reduce the power use in the memory subsystem. To meet the demand of AI, memory subsystems with low power memory having high RAS (reliability, availability, and serviceability) capabilities (e.g., SDDC (single data device correction)) are implemented. Locating high-capacity memory with high bandwidth very close to the processor (e.g., CPU (central processing unit) or GPU (graphics processing unit)) that will be performing the computations can improve memory throughput to meet the higher demands.

The current implementation of DDR5 (double data rate version 5) DRAM (dynamic random access memory) devices support a 5C granular temperature sensor. The DDR5 DIMMs (dual inline memory module) have a TSOD (thermal sensor on DIMM) to read the temperature, and include signal lines for the TSOD to communicate sensing data to the host.

Emerging DRAM devices (e.g., DDR6 (dual data rate version 6)) are expected provide the option of multichip packages, having multiple DRAM dies in a stack. Stacked DRAM device packages can increase the DRAM capacity as well as providing more memory channels (e.g., 24 to 32 DIMM channels in a 19″ rack). Increasing capacity and the number of channels increases the pressure on the thermal solution of the package, as well as the memory module (e.g., DIMM or CAMM (compression attached memory module)).

As discussed above, one significant tool to manage memory subsystem power is DRAM device refresh. The refresh rate is based on the temperature reading. As discussed herein, each DRAM die can have a thermal sensor. In one example, there is a thermal sensor per memory package, which can be implemented on the base die on which the memory dies are stacked. In one example, each DRAM die has thermal sense hardware, which can be selectively enabled and disabled. Thus, a memory stack can have a single thermal sensor per package by enabling the thermal sensor for one of the dies in the stack (e.g., the bottom die in the stack).

Where each DRAM die has a thermal sensor, the data from each DRAM die can be passed to a proxy die in the package, enabling the system to pass information from many dies to the host via the proxy die. In one example, the base die is the proxy die. In one example, the bottom memory die is the proxy die. Where there is a thermal sensor per memory package, the information from the one sensor provides information for the package and all dies in the stack can be managed based on the package temperature.

The ability to carefully monitor and handle the temperatures within each DRAM package allows the system improved control over memory throttling. By distributing the thermal situations across packages and memory modules in the memory subsystem, the system has improved control.

A TSOD does not have sufficient granularity to manage the thermal conditions inside a DRAM package with multiple memory dies. Even with two TSODs per module, there is insufficient granularity of information to accurately manage many multichip packages. In one example, the memory die thermal sensors make the TSOD unnecessary. Thus, in one example, a system with thermal sensors on the memory dies eliminates the TSODs from the memory modules.

In one example, a system has a proxy die for temperature sensor functions. In one example, a system has an initiator die for temperature sensor functions. In one example, the thermal sensors on DRAM dies as discussed above have a temperature granularity of 1C as compared to the 5C of typical TSODs. Thus, the system can not only read the temperature sensor at die level, but the granularity of temperature information will also be higher.

In one example, the proxy die or the initiator die provides the host with one temperature reading for the entire package. In one example, the single temperature reading is a worst-case temperature reading for the stack. In one example, the proxy provides temperature readings for all memory dies, such as a sequence of bytes of information, or storing the readings in a register that the host can read. Instead of connecting a sideband channel to all dies, which would significantly increase the signaling load and the pin count, the system can have only the proxy connected to the sideband channel. Having only the proxy connected to the sideband channel improves the signal integrity for the management bus, because even for a slower speed bus, such as I3C (improved inter integrated circuit), the loading and noise can reduce the signal integrity.

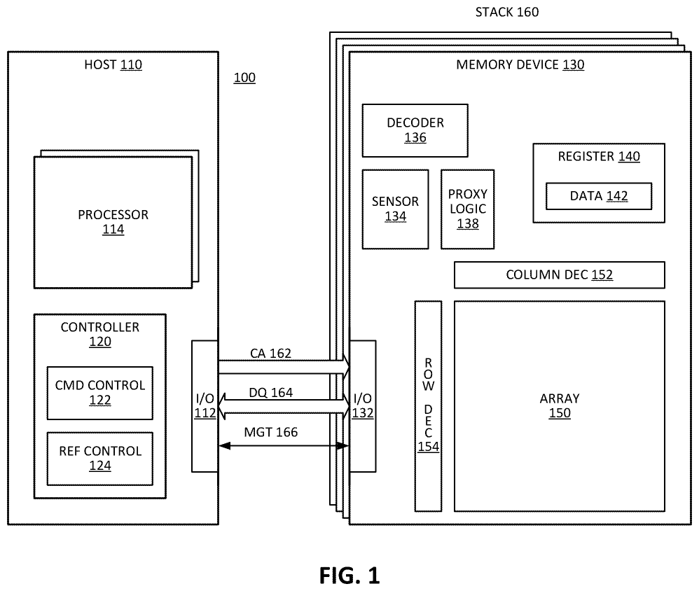

FIG. 1 is a block diagram of an example of a system that passes memory sensor information through proxy. System 100 includes host 110 with processor 114 and controller 120. Controller 120 can be a memory controller. In one example, controller 120 is an iMC (integrated memory controller).

System 100 includes stack 160, which represents a stack of memory dies. Memory device 130 represents the memory die, having array 150, which represents the memory array to store data. Memory device 130 includes decoder 136 to decode commands and register 140 to store configuration information. In one example, register 140 is a mode register. In one example, register 140 includes a field to store sensor information for multiple dies, when memory device 130 acts as a proxy die for a stack. The field is represented by data 142.

Memory device 130 includes column DEC (decoder) 152 to manage access to specific columns and bits of memory. Memory device 130 includes row DEC (decoder) 154 to manage access to selected rows of memory.

I/O (input/output) 112 represents a hardware interface of host 110 to couple to I/O (input/output) 132 of memory device 130. The interface includes CA (command/address) 162, which represents signal lines for a command and address bus. The CA bus is a unidirectional bus from controller 120 to memory device 130.

The interface includes DQ (data) 164, which represents signal lines for a data bus. The DQ bus is a bidirectional bus allowing host 110 and memory device 130 to exchange data with each other. The interface includes management bus (MGT) 166, which represents a management bus, such as an I3C (improved inter-integrated circuit), M3C (memory module management control) bus, or other management communication bus.

In one example, controller 120 includes CMD (command) control 122 and REF (refresh) control 124. Command control 122 represents logic in controller 120 to generate and send commands to memory device 130. Refresh control 124 represents refresh control logic in controller 120 to generate and send refresh to memory device 130. In one example, controller 120 adjusts the refresh timing of refresh control 124 based on temperature sensing data received from stack 160. Thus, controller 120 can adjust refresh management based on temperature sensing data or other sensor data.

In one example, each memory die in stack 160 includes sensor hardware, represented by sensor 134 of memory device 130. There are various types of sensors that can be used. In one example, sensor 134 includes a thermal sensor. In one example, each die in stack 160 includes proxy logic 138, which represents logic that enables the memory die to act as a proxy for sensor information. In one example, proxy logic 138 is part of I/O 132.

As a proxy, memory device 130 provides sensor data to host 110 on behalf of all the memory dies in stack 160. In one example, memory device 130 provides only the sensor data from its own sensor 134. In one example, memory device 130 gathers sensor data from other memory dies, determines which is the worst-case reading, and provides the information determined to represent the worst case.

In one example, data 142 represents a location in a mode register where each die stores its sensor data. In a transparent mode, the proxy can receive a request for sensor information, and initiate the other dies with the request through internal sharing. In one example, the host accesses the mode register of each die individually to determine individual sensor information. In one example, memory device 130 gathers sensor data from other memory dies and stores it as data 142 in register 140. In one example, memory device 130 provides sensor information to host 110 over management bus 166.

In one example, controller 120 can issue one or more commands to trigger thermal sensor reading or the capture of other sensor data. The proxy die can pass the command to other memory dies in the stack to cause them to also capture sensor data. In one example, controller 120 can issue an MRR (mode register read) to read temperature information from one or more of the memory dies in stack 160.

In one example, controller 120 issues the MRR command through an inband channel. In one example, controller 120 issues the MRR command through a sideband channel. It will be understood that when one channel is used to access the stack, the other channel is unavailable. For example, when accessing through the in-band channel, the sideband channel is unavailable for access. Similarly, when the sideband channel is reading, the in-band channel will not have access. The access exclusions can apply during boot time and during runtime.

In one example, each memory die in stack 160 has a device ID (identifier). In one example, to read temperature sensing information or other sensor data, controller 120 issues a read having a die address, which is the device ID. The device ID can be flashed onto the device during build/manufacture of the memory module. The device ID can be done at the ATE level using 13C for each die/stack. In one example, there is no writing to the ID register. When the system needs to read the register or a particular die within the stack, the system can use the address as: Stack ID and then Device ID (DRAMs and buffers (such as data buffers) each have their own device ID). Sideband commands can be slightly changed to accommodate the use of stack ID and device ID.

In one example, consolidation happens in one of two places: in the proxy die, or in a management component. The proxy die can refer to the DRAM die that acts as the stack proxy, or the proxy can be the DB die. In one example, the proxy die provides either the worst-case temperature reading, or it provides temperatures over a period of time. The management component can be or include the SPD, RCD, or PMIC. The component performing the consolidation can depend on the configuration, such as based on where the I3C hub resides. After consolidating the temperature sensor information from the dies in the stack, the hub device can send the information to the host for further processing.

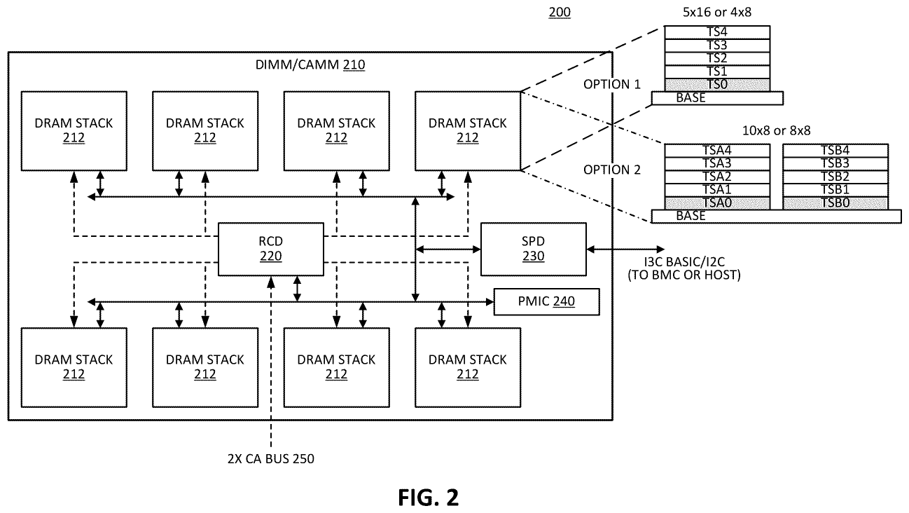

FIG. 2 is a block diagram of an example of a memory module for passing information by proxy. System 200 illustrates a memory subsystem in accordance with an example of system 100. System 200 includes memory module 210, which is identified as a DIMM or CAMM. It will be understood that the various implementations for the stacked memory can apply to DIMMs and CAMMs.

In one example, system 200 illustrates a native solution without a buffer being part of the memory package. Thus, the thermal sensor solution is not part of a buffer device. Memory module 210 of system 200 has multiple DRAM stacks 212 coupled to CA bus 250. In one example, as illustrated, memory module 210 includes RCD (registering clock driver) 220 to buffer the CA bus to the DRAM devices. In one example, memory module 210 is implemented without RCD 220, where each DRAM stack 212 includes hardware interface logic to receive and decode the CA bus signal. CA bus 250 is illustrated as a 2× data bus, referring to a double data rate command bus, which multiplexes commands for two memory channels on a single signal line.

SPD (serial presence detect) 230 represents a component on memory module 210 for management access to the DRAM stacks. In one example, SPD 230 provides access to the I3C basic bus, I2C management bus, or M3C bus. The bus can enable management access to a BMC (baseboard management controller) or directly to the host (e.g., the memory controller). PMIC (power management integrated controller) 240 can also connect to the management bus and provide power management services for the memory module.

System 200 illustrates multiple options for DRAM stacks 212. Option 1 represents a 5×16 stack or a 4×8 stack. The ‘5’ and ‘4’ represent the total number of DRAM dies in the stack. The ‘x8’ represents a x8 DQ (data bus) interface, with eight DQ signal lines per memory die. The ‘x16’ represents a x16 DQ interface, with sixteen DQ signal lines per memory die. System 200 illustrates five DRAM dies in the stack. The dies are designated based on the temperature sensing information to be provided, where it is understood each memory die has its own thermal sensor. Thus, the memory dies are represented by TS0, TS1, TS2, TS3, and TS4. In one example, the stack includes a base die on which the stack is disposed for package I/O.

Option 2 represents a package with two stacks, for an implementation of 10×8 or 8×8 in the package. The ‘10’ and ‘8’ represent the total number of DRAM dies in the package. In one example, all DRAM dies are stacked on each other, and they are managed as two separate groups, such as 10 DRAM dies in the stack treated as two group of 5, or 8 DRAM dies as two groups of 4. The ‘x8’ represents a x8 DQ interface, with eight DQ signal lines per memory die. System 200 illustrates two stacks with five DRAM dies each, with the stacks next to each other, while physically, the DRAM dies can all be in a single stack. The dies are designated based on the temperature sensing information to be provided, where it is understood each memory die has its own thermal sensor. Thus, the memory dies are represented by TSA0, TSA1, TSA2, TSA3, and TSA4 for one group, and TSB0, TSB1, TSB2, TSB3, and TSB4 for the other group. In one example, the stack includes a base die on which the stack is disposed for package I/O.

In system 200, the DRAM stack is connected natively and one of the DRAM dies in the stack acts as an initiator or a proxy to control the temperature sensing. In one example, the other DRAM dies are connected internally to the proxy die. In one example, the DRAM dies in the stack are connected through edge bonds. Alternatively, in one example, the DRAM die stack can be connected through TSV (through-silicon vias). The use of internal connection significantly reduces pin count and allows the host to receive data through the proxy.

In one example, the host polls the proxy die for sensor information. In one example, system 200 supports a transparent mode, where each die acquires its own sensor information, which the proxy die then stores for access by the host. In one example, the proxy die identifies the worst case temperature of the package to send to the host. In one example, the proxy die provides the sensor information to the host in response to a request by the host. The request can be implemented through an in-band channel (e.g., through the CA bus as a command from the host), or through a sideband channel, which represents a management channel that is not used for data access operations.

One of the dies in the stack is selected as the initiator/proxy die within the package. The designation as an initiator die refers to the fact that the die will gather the information from the other dies in response to a request or a schedule to gather sensor information. The designation as a proxy die refers to the fact that the die will proxy thermal sensing command request to the other dies in the stack and will provide the sensor information to the host on behalf of all dies in the package. For simplicity, the descriptions below will generally only refer to a “proxy die,” while it will be understood that initiator die and proxy die can be used interchangeably. In a package with two groups of dies, there can still be only one die selected to provide sensor proxying with the host, as the package is considered as a whole.

In one example, TS0 is selected as the proxy die. In the case of two groups in the stack, TSA0 can be selected as the proxy die. In one example, a different die in the die stack can be selected. The proxy die is responsible for sending the package temperature sensor information to the host. In one example, the proxy die sends the worst case temperature of the package to the host.

System 200 can use TSx[0:4] for die-based refresh rate changes. In one example, to be more precise at the die level, system 200 manages refresh rate for individual memory dies. Thus, the proxy operates in transparent mode, providing thermal sensing information for all memory dies to the host. The host generates a command for a specific die, which the proxy die receives and then transmits the command to the required die to address the more accurate refresh rate at the die level.

In one example, an I3C hub can reside in SPD 230. In one example, an I3C hub can reside in RCD 220. In one example, any one or more of RCD 220, SPD 230, PMIC 240, and the I3C hub can be combined into a single component.

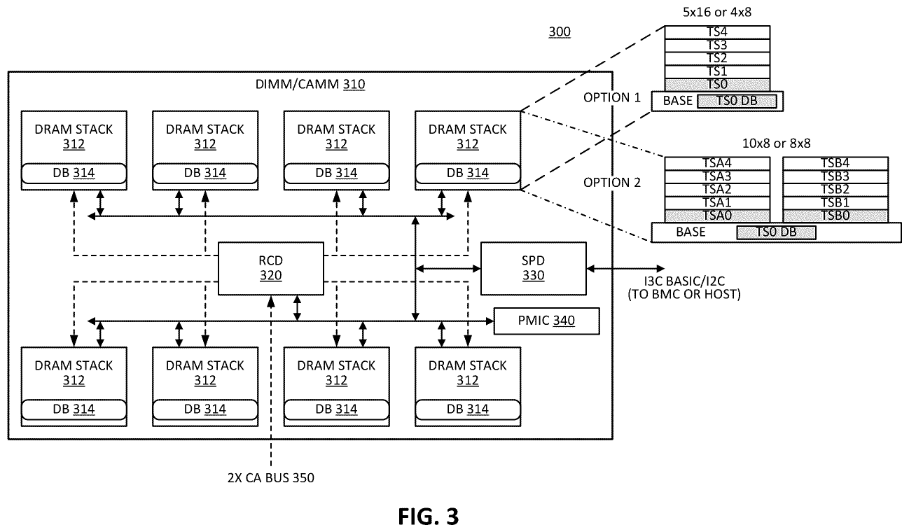

FIG. 3 is a block diagram of an example of a memory module with data buffers for passing information by proxy. System 300 illustrates a memory subsystem in accordance with an example of system 100. System 300 includes memory module 310, which is identified as a DIMM or CAMM. It will be understood that the various implementations for the stacked memory can apply to DIMMs and CAMMs.

In one example, system 200 illustrates a solution with a buffer being part of the memory package. As illustrated, each DRAM stack 312 includes DB (data buffer) 314. It will be understood that a data buffer acts as a buffer for the data bus. In one example, the buffer component can buffer the DQ (data) bus, CA (command/address) bus, and the CK (clock). In one example, where there is a buffer for the CA bus and CK, RCD 320 can be removed from the memory module, as the RCD will be distributed to each stack.

Memory module 310 of system 300 has multiple DRAM stacks 312 coupled to CA bus 350. In one example, as illustrated, memory module 310 includes RCD (registering clock driver) 320 to buffer the CA bus to the DRAM devices. In one example, memory module 310 is implemented without RCD 320, where each DRAM stack 312 includes hardware interface logic to receive and decode the CA bus signal. CA bus 350 is illustrated as a 2× data bus, referring to a double data rate command bus, which multiplexes commands for two memory channels on a single signal line.

SPD (serial presence detect) 330 represents a component on memory module 310 for management access to the DRAM stacks. In one example, SPD 330 provides access to the I3C basic bus, I2C management bus, or M3C bus. The bus can enable management access to a BMC (baseboard management controller) or directly to the host (e.g., the memory controller). PMIC (power management integrated controller) 340 can also connect to the management bus and provide power management services for the memory module.

System 300 illustrates multiple options for DRAM stacks 312. Option 1 represents a 5×16 stack or a 4×8 stack. The ‘5’ and ‘4’ represent the total number of DRAM dies in the stack. The ‘x8’ represents a x8 DQ (data bus) interface, with eight DQ signal lines per memory die. The ‘x16’ represents a x16 DQ interface, with sixteen DQ signal lines per memory die. System 300 illustrates five DRAM dies in the stack. The dies are designated based on the temperature sensing information to be provided, where it is understood each memory die has its own thermal sensor. Thus, the memory dies are represented by TS0, TS1, TS2, TS3, and TS4. In one example, the stack includes a base die on which the stack is disposed for package I/O.

Option 2 represents a package with two stacks, for an implementation of 10×8 or 8×8 in the package. The ‘10’ and ‘8’ represent the total number of DRAM dies in the package. In one example, all DRAM dies are stacked on each other, and they are managed as two separate groups, such as 10 DRAM dies in the stack treated as two group of 5, or 8 DRAM dies as two groups of 4. The ‘x8’ represents a x8 DQ interface, with eight DQ signal lines per memory die. System 200 illustrates two stacks with five DRAM dies each, with the stacks next to each other, while physically, the DRAM dies can all be in a single stack. The dies are designated based on the temperature sensing information to be provided, where it is understood each memory die has its own thermal sensor. Thus, the memory dies are represented by TSA0, TSA1, TSA2, TSA3, and TSA4 for one group, and TSB0, TSB1, TSB2, TSB3, and TSB4 for the other group. In one example, the stack includes a base die on which the stack is disposed for package I/O.

In system 300, the DRAM stack is connected natively and one of the DRAM dies in the stack acts as an initiator or a proxy to control the temperature sensing. In one example, the other DRAM dies are connected internally to the proxy die. In one example, the DRAM dies in the stack are connected through edge bonds. Alternatively, in one example, the DRAM die stack can be connected through TSV (through-silicon vias). The use of internal connection significantly reduces pin count and allows the host to receive data through the proxy.

In one example, the host polls the proxy die for sensor information. In one example, system 300 supports a transparent mode, where each die acquires its own sensor information, which the proxy die then stores for access by the host. In one example, the proxy die identifies the worst case temperature of the package to send to the host. In one example, the proxy die provides the sensor information to the host in response to a request by the host. The request can be implemented through an in-band channel (e.g., through the CA bus as a command from the host), or through a sideband channel, which represents a management channel that is not used for data access operations.

One of the dies in the stack is selected as the initiator/proxy die within the package. The designation as an initiator die refers to the fact that the die will gather the information from the other dies in response to a request or a schedule to gather sensor information. The designation as a proxy die refers to the fact that the die will proxy thermal sensing command request to the other dies in the stack and will provide the sensor information to the host on behalf of all dies in the package. For simplicity, the descriptions below will generally only refer to a “proxy die,” while it will be understood that initiator die and proxy die can be used interchangeably. In a package with two groups of dies, there can still be only one die selected to provide sensor proxying with the host, as the package is considered as a whole.

In one example, TS0 is selected as the proxy die. In the case of two groups in the stack, TSA0 can be selected as the proxy die. In one example, the base die with the buffer (e.g., DB 314) can be selected as the proxy die. In one example, a different die in the die stack can be selected. The proxy die is responsible for sending the package temperature sensor information to the host. In one example, the proxy die sends the worst case temperature of the package to the host.

System 300 can use TSx[0:4] for die-based refresh rate changes. In one example, to be more precise at the die level, system 300 manages refresh rate for individual memory dies. Thus, the proxy operates in transparent mode, providing thermal sensing information for all memory dies to the host. The host generates a command for a specific die, which the proxy die receives and then transmits the command to the required die to address the more accurate refresh rate at the die level.

As described in system 200 and system 300, the system provides a proxy function in one of the DRAM dies or part of the buffer which is part of the DRAM package. In one example, only the proxy die is connected through the package I/O interface to other components in the system. Thus, only the proxy die can receive commands through the command channel and will provide information through the command channel to the host. The other dies in the stack are internally bonded (e.g., edge wire bonded or TSV) to the proxy die to communicate within the package. Limiting external connection to the proxy die ensures that the pin count of the package does not increase. Additionally, limiting the external connection to the proxy die reduces signal loading and avoids miscommunications between the host and the DIMM module. For example, consider an inband interrupt from each DRAM die is getting triggered as part of sideband communication, the host would spend a significant amount of time serving those requests.

In one example, an I3C hub can reside in SPD 330. In one example, an I3C hub can reside in RCD 320. In one example, any one or more of RCD 320, SPD 330, PMIC 340, and the I3C hub can be combined into a single component.

In one example, the proxy die is selected as boot time. In one example, the bottom-most die in the stack is selected as the proxy die. In one example, the sensor data for each die is a byte of information.

A system as described herein enables better refresh rates at the die level and the package level, without having too many pins per package or too many pins at the module level. As described above, the integration of sensors into the DRAM die can enable the system to remove TS0D. In one example, DTS can be implemented as part of the DRAM package. By consolidating the sensor information through the proxy die, the information can be more easily passed to the RCD or SPD or the host, while minimizing the sideband communication for temperature sensing or other sensor information that is aggregated at a proxy. While the descriptions are focused on temperature sensing, it will be understood that similar consolidation and proxy operation can be applied to termination adjustments, Vref (reference voltage) adjustments, or both termination and Vref adjustments. Thus, termination, or Vref, or both, can be provided across dies from the proxy die for the entire package.

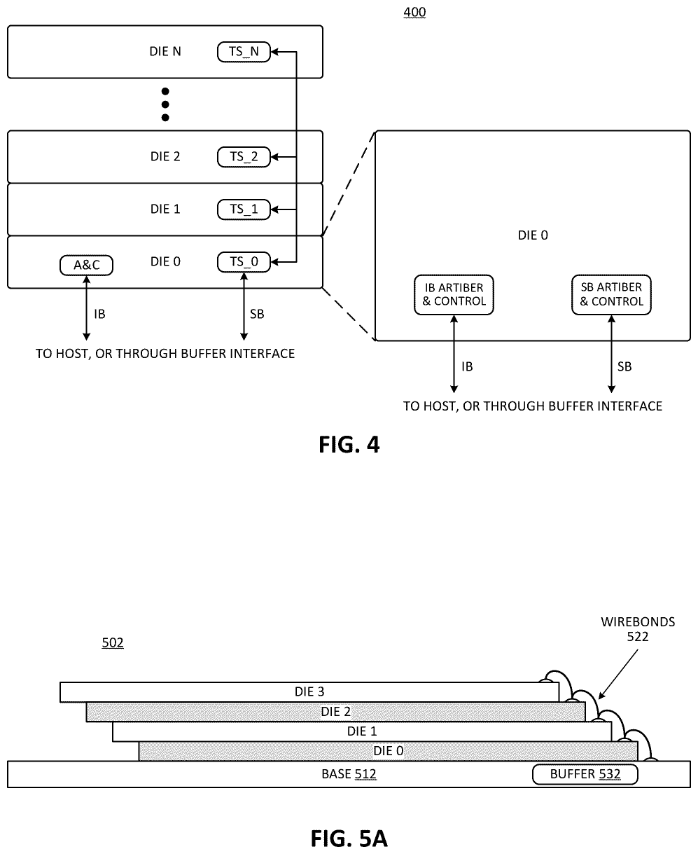

FIG. 4 is a block diagram of an example of a memory stack that extends sensor function through information passing by proxy. System 400 illustrates a memory stack in accordance with an example of system 100, an example of system 200, or an example of system 300. System 400 illustrates a memory die stack with thermal sensors, which can be applied to other sensors or other component configuration as described above.

System 400 illustrates Die[0:N]. In one example, Die 0 acts as the proxy die for the stack. Each of Die[0:N] includes a corresponding thermal sensor (TS_0, TS_1, TS_2, . . . , TS_N). In one example, the proxy die (Die 0 as illustrated) includes arbiter and control logic (A&C). The arbiter and control enables the proxy die to select between inband (IB) communication and sideband (SB) communication. In one example, there is separate arbiter and control logic for the IB and arbiter and control logic for the SB.

In one example, the proxy die communicates directly to the host. In one example, the proxy die communicates through a buffer interface, where the buffer can be a DQ buffer, or a DQ buffer and CA and CK buffer. In one example, the buffer device is the proxy die and includes the arbiter logic and control.

System 400 illustrates how an in-band channel and a sideband channel can access the temperature sensor details. A request for temperature information can go through the proxy die, which internally sends the request to the other dies to figure out the worst case temperature value (for a single value presented), or sensor information for all dies for transparent mode, and send the temperature information back to the host. In one example, in transparent mode, the host can directly access the mode register part of a specific DRAM die to address specific throttling needs instead of looking at the package level. In one example, the transparent mode can be used for validation purposes.

In addition to the thermal sensing information as described, the proxy concept can be extended to the possibility of controlling other functionalities from the proxy chip. Examples include: ZQCAL (impedance calibration), Vref setup (setting up Vref values directly to the MRs (mode registers)), termination settings, or other settings. The internal wiring of ZQ and internal wires which can act as a communication channel that is not visible external to the package.

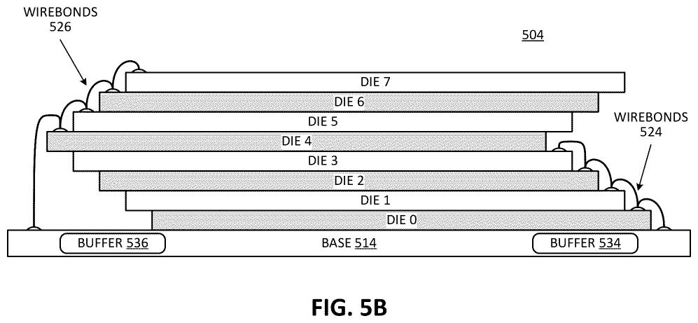

FIG. 5A is a block diagram of an example of an offset memory stack with four memory dies. System 502 illustrates a memory die stack with thermal sensors, which can be applied to other sensors or other component configuration as described above. System 502 does not specifically illustrate the aggregation circuits that combine the sensor data from different memory dies in the stack.

It will be understood that other examples illustrated five memory dies in the stack, and another memory die could accordingly be added to the stack in system 502. System 502 illustrates Die 0, Die 1, Die 2, and Die 3 on base 512, which represents a base die. In one example, base 512 includes buffer 532, which can be a data buffer, or can represent DQ, CA, and CK buffering. The buffer is optional.

System 502 illustrates wirebonds 522, which represent edge wire bonds. Wirebonds 522 are on an edge of the die, where the edges are exposed in the stack by the offset of one die stacked on the die below it. One of the dies in the stack is selected as the proxy die. In one example, the buffer is selected as the proxy die.

In one example, each die in the stack has a device ID allocated based on the serial number. The device ID can be assigned during the boot up sequence. The sideband channel is not specifically illustrated, but the sideband channel address a specific DRAM die to get the temperature sensor information through the proxy device.

If a buffer is included, attaching the buffer closer to the DRAM dies enables the system to avoid or significantly reduce DFE (decision feedback equalization) circuits. Additionally, mounting the buffer close to the DRAM dies, by putting it in the DRAM die stack package, can help with the backside training engine.

FIG. 5B is a block diagram of an example of an offset memory stack with eight memory dies. System 504 illustrates a memory die stack with thermal sensors, which can be applied to other sensors or other component configuration as described above. System 502 does not specifically illustrate the aggregation circuits that combine the sensor data from different memory dies in the stack.

It will be understood that other examples illustrated five memory dies per group in the stack, and two more memory dies could accordingly be added to the stack in system 504. System 504 illustrates Die 0, Die 1, Die 2, Die 3, Die 4, Die 5, Die 6, and Die 7 on base 514, which represents a base die.

System 504 illustrates wirebonds 524, which represent edge wire bonds for Die[0:3], and wirebonds 526, which represent edge wire bonds for Die[4:7]. Wirebonds 524 and wirebonds 526 are on an edge of the die, where the edges are exposed in the stack by the offset of one die stacked on the die below it. One of the dies in the stack is selected as the proxy die. In one example, the buffer is selected as the proxy die.

In one example, each die in the stack has a device ID allocated based on the serial number. The device ID can be assigned during the boot up sequence. The sideband channel is not specifically illustrated, but the sideband channel address a specific DRAM die to get the temperature sensor information through the proxy device.

In one example, base 514 includes buffer 534, which can be a data buffer, or can represent DQ, CA, and CK buffering, for Die[0:3]. In one example, base 514 includes buffer 536, which can be a data buffer, or can represent DQ, CA, and CK buffering, for Die[4:7]. The buffers are optional. In one example, there is one buffer for all dies.

If a buffer is included, attaching the buffer closer to the DRAM dies enables the system to avoid or significantly reduce DFE (decision feedback equalization) circuits. Additionally, mounting the buffer close to the DRAM dies, by putting it in the DRAM die stack package, can help with the backside training engine.

The wirebonds for the two different groups of dies in the stack are illustrated as coming to different sides of base 514. The illustration is simply for purposes of simplicity in representing the wire bonds for the different groups of dies in the stack. In one example, all wirebonds from the stack will come to the same side of base 514. In one example, instead of having all signal lines for all dies come to the I/O for base 514, the two groups of dies in the stack are routed to the same I/O hardware, which is then multiplexed between the two groups. The two groups can be separate ranks, referring to being activated/selected by the same CS (chip select) signal. Thus, the mux can be controlled based on the CS signal.

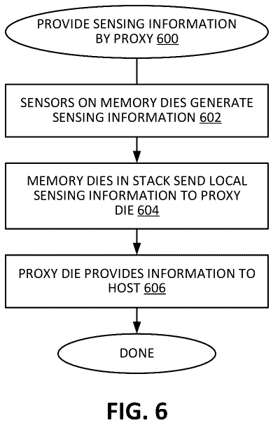

FIG. 6 is a flow diagram of an example of a process for providing sensing information by proxy. Process 600 illustrates a process to provide sensing information by proxy, in accordance with any example herein.

In one example, sensors on the memory dies generate sensing information local to each die in the stack, block 602. In one example, the memory dies store their data locally in a register (e.g., a mode register). In one example, the memory dies send their data through internal stack routing to the proxy die, block 604. In one example, the dies store their data locally and send the data to the proxy die. The proxy die provides sensing information to the host, block 606.

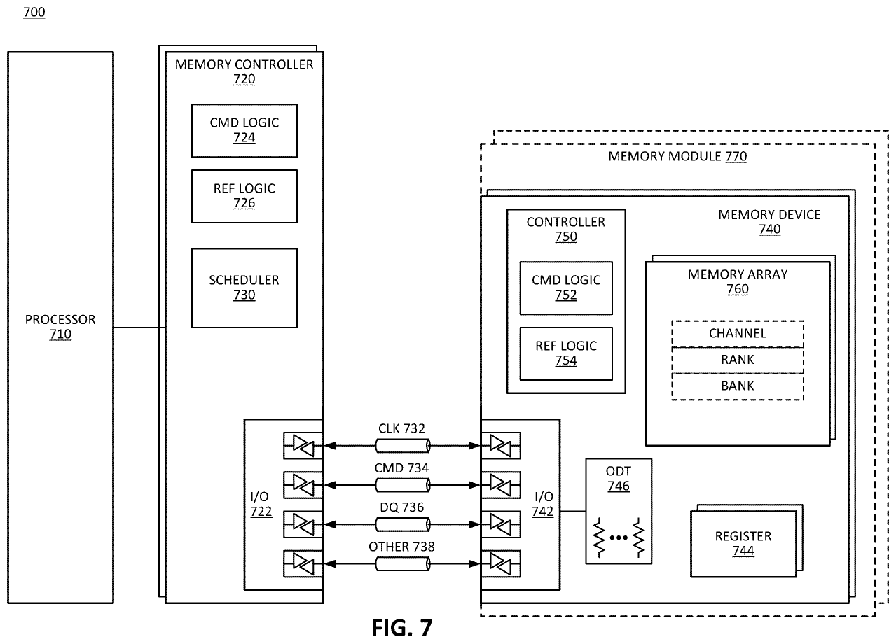

FIG. 7 is a block diagram of an example of a memory subsystem in which passing sensing information by proxy can be implemented. System 700 includes a processor and elements of a memory subsystem in a computing device. System 700 represents a system in accordance with an example of system 100, system 200, system 300, or system 400.

In one example, system 700 includes memory die stacks in memory module 770. The stacks include a proxy die in accordance with any example herein, which can be memory device 740 or a buffer device (not specifically illustrated). The proxy operation can be in accordance with any example herein.

Processor 710 represents a processing unit of a computing platform that may execute an OS (operating system) and applications, which can collectively be referred to as the host or the user of the memory. The OS and applications execute operations that result in memory accesses. Processor 710 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory accesses may also be initiated by devices such as a network controller or hard disk controller. Such devices can be integrated with the processor in some systems or attached to the processer via a bus (e.g., PCI express), or a combination. System 700 can be implemented as an SOC (system on a chip), or be implemented with standalone components.

Reference to memory devices can apply to different memory types. Memory devices often refers to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random-access memory), or some variant such as synchronous DRAM (SDRAM). A memory subsystem as described herein may be compatible with a number of memory technologies, such as DDR5 (double data rate version 5, originally published by JEDEC (Joint Electron Device Engineering Council, now the JEDEC Solid State Technology Association) in July 2020), LPDDR5 (low power DDR version 5, JESD209-5, originally published by JEDEC in February 2019), HBM2 (high bandwidth memory version 2, JESD235C, originally published by JEDEC in January 2020), HBM3 (HBM version 3, JESD238, originally published by JEDEC in January 2022), DDR6 (DDR version 6, currently in discussion by JEDEC), LPDDR5 (LPDDR version 6, currently in discussion by JEDEC), or others or combinations of memory technologies, and technologies based on derivatives or extensions of such specifications.

Memory controller 720 represents one or more memory controller circuits or devices for system 700. Memory controller 720 represents control logic that generates memory access commands in response to the execution of operations by processor 710. Memory controller 720 accesses one or more memory devices 740. Memory devices 740 can be DRAM devices in accordance with any referred to above. In one example, memory devices 740 are organized and managed as different channels, where each channel couples to buses and signal lines that couple to multiple memory devices in parallel. Each channel is independently operable. Thus, each channel is independently accessed and controlled, and the timing, data transfer, command and address exchanges, and other operations are separate for each channel. Coupling can refer to an electrical coupling, communicative coupling, physical coupling, or a combination of these. Physical coupling can include direct contact. Electrical coupling includes an interface or interconnection that allows electrical flow between components, or allows signaling between components, or both. Communicative coupling includes connections, including wired or wireless, that enable components to exchange data.

In one example, settings for each channel are controlled by separate mode registers or other register settings. In one example, each memory controller 720 manages a separate memory channel, although system 700 can be configured to have multiple channels managed by a single controller, or to have multiple controllers on a single channel. In one example, memory controller 720 is part of host processor 710, such as logic implemented on the same die or implemented in the same package space as the processor.

Memory controller 720 includes I/O interface logic 722 to couple to a memory bus, such as a memory channel as referred to above. I/O interface logic 722 (as well as I/O interface logic 742 of memory device 740) can include pins, pads, connectors, signal lines, traces, or wires, or other hardware to connect the devices, or a combination of these. I/O interface logic 722 can include a hardware interface. As illustrated, I/O interface logic 722 includes at least drivers/transceivers for signal lines. Commonly, wires within an integrated circuit interface couple with a pad, pin, or connector to interface signal lines or traces or other wires between devices. I/O interface logic 722 can include drivers, receivers, transceivers, or termination, or other circuitry or combinations of circuitry to exchange signals on the signal lines between the devices. The exchange of signals includes at least one of transmit or receive. While shown as coupling I/O 722 from memory controller 720 to I/O 742 of memory device 740, it will be understood that in an implementation of system 700 where groups of memory devices 740 are accessed in parallel, multiple memory devices can include I/O interfaces to the same interface of memory controller 720. In an implementation of system 700 including one or more memory modules 770, I/O 742 can include interface hardware of the memory module in addition to interface hardware on the memory device itself. Other memory controllers 720 will include separate interfaces to other memory devices 740.

The bus between memory controller 720 and memory devices 740 can be implemented as multiple signal lines coupling memory controller 720 to memory devices 740. The bus may typically include at least clock (CLK) 732, command/address (CMD) 734, and write data (DQ) and read data (DQ) 736, and zero or more other signal lines 738. In one example, a bus or connection between memory controller 720 and memory can be referred to as a memory bus. In one example, the memory bus is a multi-drop bus. The signal lines for CMD can be referred to as a “C/A bus” (or ADD/CMD bus, or some other designation indicating the transfer of commands (C or CMD) and address (A or ADD) information) and the signal lines for write and read DQ can be referred to as a “data bus.” In one example, independent channels have different clock signals, C/A buses, data buses, and other signal lines. Thus, system 700 can be considered to have multiple “buses,” in the sense that an independent interface path can be considered a separate bus. It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 720 and memory devices 740. An example of a serial bus technology is 8B10B encoding and transmission of high-speed data with embedded clock over a single differential pair of signals in each direction. In one example, CMD 734 represents signal lines shared in parallel with multiple memory devices. In one example, multiple memory devices share encoding command signal lines of CMD 734, and each has a separate chip select (CS_n) signal line to select individual memory devices.

It will be understood that in the example of system 700, the bus between memory controller 720 and memory devices 740 includes a subsidiary command bus CMD 734 and a subsidiary bus to carry the write and read data, DQ 736. In one example, the data bus can include bidirectional lines for read data and for write/command data. In another example, the subsidiary bus DQ 736 can include unidirectional write signal lines for write and data from the host to memory, and can include unidirectional lines for read data from the memory to the host. In accordance with the chosen memory technology and system design, other signals 738 may accompany a bus or sub bus, such as strobe lines DQS. Based on design of system 700, or implementation if a design supports multiple implementations, the data bus can have more or less bandwidth per memory device 740. For example, the data bus can support memory devices that have either a x4 interface, a x8 interface, a x16 interface, or other interface. The convention “xW,” where W is an integer that refers to an interface size or width of the interface of memory device 740, which represents a number of signal lines to exchange data with memory controller 720. The interface size of the memory devices is a controlling factor on how many memory devices can be used concurrently per channel in system 700 or coupled in parallel to the same signal lines. In one example, high bandwidth memory devices, wide interface devices, or stacked memory configurations, or combinations, can enable wider interfaces, such as a x128 interface, a x256 interface, a x512 interface, a x1024 interface, or other data bus interface width.

In one example, memory devices 740 and memory controller 720 exchange data over the data bus in a burst, or a sequence of consecutive data transfers. The burst corresponds to a number of transfer cycles, which is related to a bus frequency. In one example, the transfer cycle can be a whole clock cycle for transfers occurring on a same clock or strobe signal edge (e.g., on the rising edge). In one example, every clock cycle, referring to a cycle of the system clock, is separated into multiple unit intervals (UIs), where each UI is a transfer cycle. For example, double data rate transfers trigger on both edges of the clock signal (e.g., rising and falling). A burst can last for a configured number of UIs, which can be a configuration stored in a register, or triggered on the fly. For example, a sequence of eight consecutive transfer periods can be considered a burst length eight (BL8), and each memory device 740 can transfer data on each UI. Thus, a x8 memory device operating on BL8 can transfer 64 bits of data (8 data signal lines times 8 data bits transferred per line over the burst). It will be understood that this simple example is merely an illustration and is not limiting.

Memory devices 740 represent memory resources for system 700. In one example, each memory device 740 is a separate memory die. In one example, each memory device 740 can interface with multiple (e.g., 2) channels per device or die. Each memory device 740 includes I/O interface logic 742, which has a bandwidth determined by the implementation of the device (e.g., x16 or x8 or some other interface bandwidth). I/O interface logic 742 enables the memory devices to interface with memory controller 720. I/O interface logic 742 can include a hardware interface, and can be in accordance with I/O 722 of memory controller, but at the memory device end. In one example, multiple memory devices 740 are connected in parallel to the same command and data buses. In another example, multiple memory devices 740 are connected in parallel to the same command bus, and are connected to different data buses. For example, system 700 can be configured with multiple memory devices 740 coupled in parallel, with each memory device responding to a command, and accessing memory resources 760 internal to each. For a Write operation, an individual memory device 740 can write a portion of the overall data word, and for a Read operation, an individual memory device 740 can fetch a portion of the overall data word. The remaining bits of the word will be provided or received by other memory devices in parallel.

In one example, memory devices 740 are disposed directly on a motherboard or host system platform (e.g., a PCB (printed circuit board) or substrate on which processor 710 is disposed) of a computing device. In one example, memory devices 740 can be organized into memory modules 770. In one example, memory modules 770 represent DIMMs (dual inline memory modules). In one example, memory modules 770 represent other organization of multiple memory devices to share at least a portion of access or control circuitry, which can be a separate circuit, a separate device, or a separate board from the host system platform. Memory modules 770 can include multiple memory devices 740, and the memory modules can include support for multiple separate channels to the included memory devices disposed on them. In another example, memory devices 740 may be incorporated into the same package as memory controller 720, such as by techniques such as MCM (multi-chip-module), package-on-package, TSV (through-silicon via), or other techniques or combinations. Similarly, in one example, multiple memory devices 740 may be incorporated into memory modules 770, which themselves may be incorporated into the same package as memory controller 720. It will be appreciated that for these and other implementations, memory controller 720 may be part of host processor 710.

Memory devices 740 each include one or more memory arrays 760. Memory array 760 represents addressable memory locations or storage locations for data. Typically, memory array 760 is managed as rows of data, accessed via wordline (rows) and bitline (individual bits within a row) control. Memory array 760 can be organized as separate channels, ranks, and banks of memory. Channels may refer to independent control paths to storage locations within memory devices 740. Ranks may refer to common locations across multiple memory devices (e.g., same row addresses within different devices) in parallel. Banks may refer to sub-arrays of memory locations within a memory device 740. In one example, banks of memory are divided into sub-banks with at least a portion of shared circuitry (e.g., drivers, signal lines, control logic) for the sub-banks, allowing separate addressing and access. It will be understood that channels, ranks, banks, sub-banks, bank groups, or other organizations of the memory locations, and combinations of the organizations, can overlap in their application to physical resources. For example, the same physical memory locations can be accessed over a specific channel as a specific bank, which can also belong to a rank. Thus, the organization of memory resources will be understood in an inclusive, rather than exclusive, manner.

In one example, memory devices 740 include one or more registers 744. Register 744 represents one or more storage devices or storage locations that provide configuration or settings for the operation of the memory device. In one example, register 744 can provide a storage location for memory device 740 to store data for access by memory controller 720 as part of a control or management operation. In one example, register 744 includes one or more Mode Registers. In one example, register 744 includes one or more multipurpose registers. The configuration of locations within register 744 can configure memory device 740 to operate in different “modes,” where command information can trigger different operations within memory device 740 based on the mode. Additionally, or in the alternative, different modes can also trigger different operation from address information or other signal lines depending on the mode. Settings of register 744 can indicate configuration for I/O settings (e.g., timing, termination or ODT (on-die termination) 746, driver configuration, or other I/O settings).

In one example, memory device 740 includes ODT 746 as part of the interface hardware associated with I/O 742. ODT 746 can be configured as mentioned above, and provide settings for impedance to be applied to the interface to specified signal lines. In one example, ODT 746 is applied to DQ signal lines. In one example, ODT 746 is applied to command signal lines. In one example, ODT 746 is applied to address signal lines. In one example, ODT 746 can be applied to any combination of the preceding. The ODT settings can be changed based on whether a memory device is a selected target of an access operation or a non-target device. ODT 746 settings can affect the timing and reflections of signaling on the terminated lines. Careful control over ODT 746 can enable higher-speed operation with improved matching of applied impedance and loading. ODT 746 can be applied to specific signal lines of I/O interface 742, 722 (for example, ODT for DQ lines or ODT for CA lines), and is not necessarily applied to all signal lines.

Memory device 740 includes controller 750, which represents control logic within the memory device to control internal operations within the memory device. For example, controller 750 decodes commands sent by memory controller 720 and generates internal operations to execute or satisfy the commands. Controller 750 can be referred to as an internal controller, and is separate from memory controller 720 of the host. Controller 750 can determine what mode is selected based on register 744, and configure the internal execution of operations for access to memory resources 760 or other operations based on the selected mode. Controller 750 generates control signals to control the routing of bits within memory device 740 to provide a proper interface for the selected mode and direct a command to the proper memory locations or addresses. Controller 750 includes command logic 752, which can decode command encoding received on command and address signal lines. Thus, command logic 752 can be or include a command decoder. With command logic 752, memory device can identify commands and generate internal operations to execute requested commands.

Referring again to memory controller 720, memory controller 720 includes command (CMD) logic 724, which represents logic or circuitry to generate commands to send to memory devices 740. The generation of the commands can refer to the command prior to scheduling, or the preparation of queued commands ready to be sent. Generally, the signaling in memory subsystems includes address information within or accompanying the command to indicate or select one or more memory locations where the memory devices should execute the command. In response to scheduling of transactions for memory device 740, memory controller 720 can issue commands via I/O 722 to cause memory device 740 to execute the commands. In one example, controller 750 of memory device 740 receives and decodes command and address information received via I/O 742 from memory controller 720. Based on the received command and address information, controller 750 can control the timing of operations of the logic and circuitry within memory device 740 to execute the commands. Controller 750 is responsible for compliance with standards or specifications within memory device 740, such as timing and signaling requirements. Memory controller 720 can implement compliance with standards or specifications by access scheduling and control.

Memory controller 720 includes scheduler 730, which represents logic or circuitry to generate and order transactions to send to memory device 740. From one perspective, the primary function of memory controller 720 could be said to schedule memory access and other transactions to memory device 740. Such scheduling can include generating the transactions themselves to implement the requests for data by processor 710 and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

Memory controller 720 typically includes logic such as scheduler 730 to allow selection and ordering of transactions to improve performance of system 700. Thus, memory controller 720 can select which of the outstanding transactions should be sent to memory device 740 in which order, which is typically achieved with logic much more complex than a simple first-in first-out algorithm. Memory controller 720 manages the transmission of the transactions to memory device 740, and manages the timing associated with the transaction. In one example, transactions have deterministic timing, which can be managed by memory controller 720 and used in determining how to schedule the transactions with scheduler 730.

In one example, memory controller 720 includes refresh (REF) logic 726. Refresh logic 726 can be used for memory resources that are volatile and need to be refreshed to retain a deterministic state. In one example, refresh logic 726 indicates a location for refresh, and a type of refresh to perform. Refresh logic 726 can trigger self-refresh within memory device 740, or execute external refreshes which can be referred to as auto refresh commands) by sending refresh commands, or a combination. In one example, controller 750 within memory device 740 includes refresh logic 754 to apply refresh within memory device 740. In one example, refresh logic 754 generates internal operations to perform refresh in accordance with an external refresh received from memory controller 720. Refresh logic 754 can determine if a refresh is directed to memory device 740, and what memory resources 760 to refresh in response to the command.

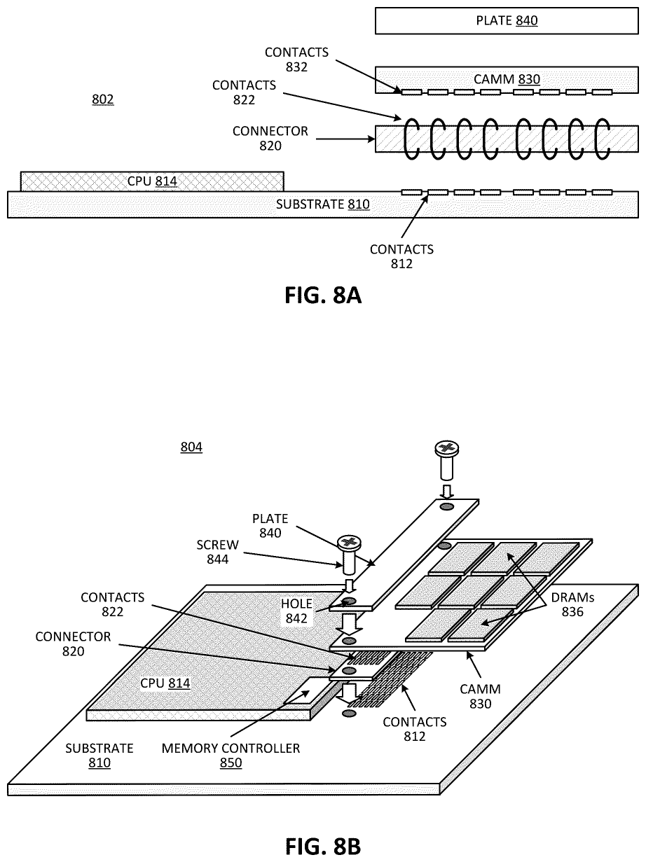

FIGS. 8A-8B are block diagrams of an example of a CAMM system in which passing sensing information by proxy can be implemented.

Referring to FIG. 8A, system 802 includes a memory stack architecture monitored by a memory fault tracker that can perform mirroring. System 802 represents a system in accordance with an example of system 100, system 200, system 300, or system 400.

Substrate 810 illustrates an SOC package substrate or a motherboard or system board. Substrate 810 includes contacts 812, which represent contacts for connecting with memory. CPU 814 represents a processor or CPU (central processing unit) chip or GPU (graphics processing unit) chip to be disposed on substrate 810. CPU 814 performs the computational operations in system 802. In one example, CPU 814 includes multiple cores (not specifically shown), which can generate operations that request data to be read from and written to memory. CPU 814 can include a memory controller to manage access to the memory devices.

CAMM (compression-attached memory module) 830 represents a module with memory devices, which are not specifically illustrated in system 802. Substrate 810 couples to CAMM 830 and its memory devices through CMT (compression mount technology) connector 820. Connector 820 includes contacts 822, which are compression-based contacts. The compression-based contacts are compressible pins or devices whose shape compresses with the application of pressure on connector 820. In one example, contacts 822 represent C-shaped pins as illustrated. In one example, contacts 822 represent another compressible pin shape, such as a spring-shape, an S-shape, or pins having other shapes that can be compressed. CAMM 830 includes contacts 832 on a side of the CAMM board that interfaces with connector 820. Contacts 832 connect to memory devices on the CAMM board.

Referring to FIG. 8B, system 804 is a perspective view of a system in accordance with system 802. System 804 illustrates memory controller 850, which is not specifically illustrated in system 802. Memory controller 850 can provide row hammer mitigation to DRAMs 836. DRAMs 836 can be connected to memory controller 850 with an alert signal line. System 804 enables DRAMs 836 to perform an alert signal test mode with memory controller 850 in accordance with any example herein.

CAMM 830 is illustrated with memory chips or memory dies, identified as DRAMs 836 on one or both faces of the PCB of CAMM 830. DRAMs 836 are coupled with conductive contacts via conductive traces in or on the PCB, which couples with contacts 832, which in turn couple with contacts 822 of connector 820.

System 804 illustrates holes 842 in plate 840 to receive fasteners, represented by screws 844. There are corresponding holes through CAMM 830, connector 820, and in substrate 810. Screws 844 can compressibly attach the CAMM 830 to substrate 810 via connector 820.

In one example, system 804 includes DRAMs 836 that are memory die stacks. The stacks include a proxy die in accordance with any example herein, which can be memory die or a buffer device (not specifically illustrated). The proxy operation can be in accordance with any example herein.

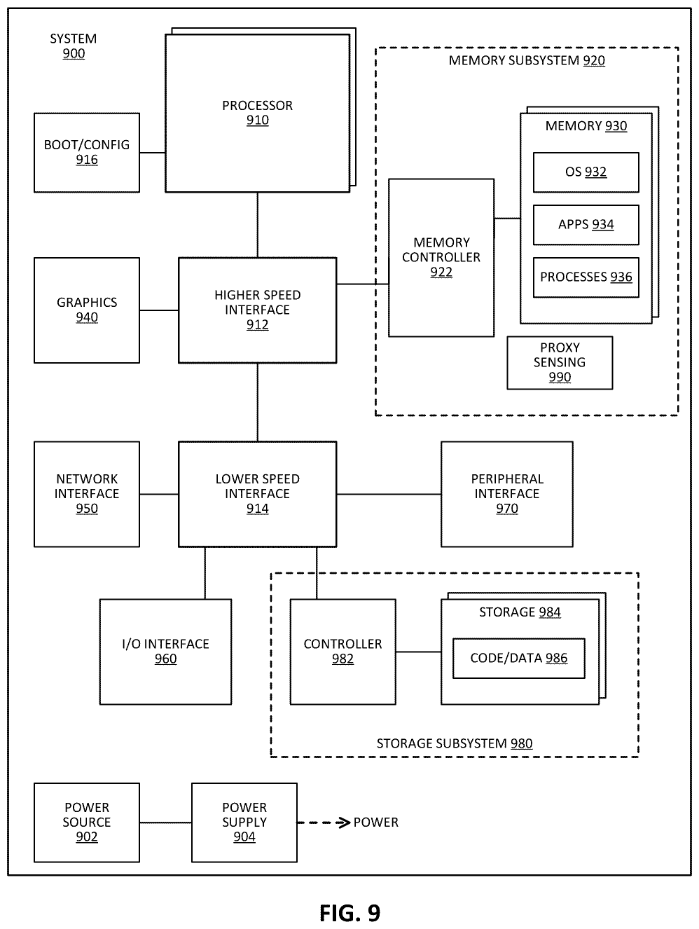

FIG. 9 is a block diagram of an example of a computing system in which passing sensing information by proxy can be implemented. System 900 represents a computing device in accordance with any example herein, and can be a laptop computer, a desktop computer, a tablet computer, a server, a gaming or entertainment control system, embedded computing device, or other electronic device.

System 900 represents a system in accordance with an example of system 100, system 200, system 300, or system 400. In one example, system 900 includes memory die stacks in memory subsystem 920. The stacks include a proxy die in accordance with any example herein, which can be memory die or a buffer device (not specifically illustrated). Proxy sensing 990 represents proxy operation in accordance with any example herein.

System 900 includes processor 910 and can include any type of microprocessor, CPU (central processing unit), GPU (graphics processing unit), processing core, or other processing hardware, or a combination, to provide processing or execution of instructions for system 900. Processor 910 can be a host processor device. Processor 910 controls the overall operation of system 900, and can be or include, one or more programmable general-purpose or special-purpose microprocessors, DSPs (digital signal processors), programmable controllers, ASICs (application specific integrated circuits), PLDs (programmable logic devices), or a combination of such devices.

System 900 includes boot/config 916, which represents storage to store boot code (e.g., BIOS (basic input/output system)), configuration settings, security hardware (e.g., TPM (trusted platform module)), or other system level hardware that operates outside of a host OS. Boot/config 916 can include a nonvolatile storage device, such as ROM (read-only memory), flash memory, or other memory devices.

In one example, system 900 includes interface 912 coupled to processor 910, which can represent a higher speed interface or a high throughput interface for system components that need higher bandwidth connections, such as memory subsystem 920 or graphics interface components 940. Interface 912 represents an interface circuit, which can be a standalone component or integrated onto a processor die. Interface 912 can be integrated as a circuit onto the processor die or integrated as a component on a system on a chip. Where present, graphics interface 940 interfaces to graphics components for providing a visual display to a user of system 900. Graphics interface 940 can be a standalone component or integrated onto the processor die or system on a chip. In one example, graphics interface 940 can drive a high definition display that provides an output to a user. In one example, the display can include a touchscreen display. In one example, graphics interface 940 generates a display based on data stored in memory 930 or based on operations executed by processor 910 or both.

Memory subsystem 920 represents the main memory of system 900, and provides storage for code to be executed by processor 910, or data values to be used in executing a routine. Memory subsystem 920 can include one or more varieties of RAM (random-access memory) such as DRAM, 3DXP (three-dimensional crosspoint), or other memory devices, or a combination of such devices. Memory 930 stores and hosts, among other things, OS (operating system) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910, such as integrated onto the processor die or a system on a chip.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a PCI (peripheral component interconnect) bus, a USB (universal serial bus), or other bus, or a combination.

In one example, system 900 includes interface 914, which can be coupled to interface 912. Interface 914 can be a lower speed interface than interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can exchange data with a remote device, which can include sending data stored in memory or receiving data to be stored in memory.

In one example, system 900 includes one or more I/O (input/output) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, NAND, 3DXP, or optical based disks, or a combination. Storage 984 holds code or instructions and data 986 in a persistent state (i.e., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (i.e., the value or state of the data is indeterminate if power is interrupted to system 900). In one example, storage subsystem 980 includes controller 982 to interface with storage 984. In one example controller 982 is a physical part of interface 914 or processor 910, or can include circuits or logic in both processor 910 and interface 914.

Power source 902 provides power to the components of system 900. More specifically, power source 902 typically interfaces to one or multiple power supplies 904 in system 900 to provide power to the components of system 900. In one example, power supply 904 includes an AC to DC (alternating current to direct current) adapter to plug into a wall outlet. Such AC power can be renewable energy (e.g., solar power) power source 902. In one example, power source 902 includes a DC power source, such as an external AC to DC converter. In one example, power source 902 or power supply 904 includes wireless charging hardware to charge via proximity to a charging field. In one example, power source 902 can include an internal battery or fuel cell source.

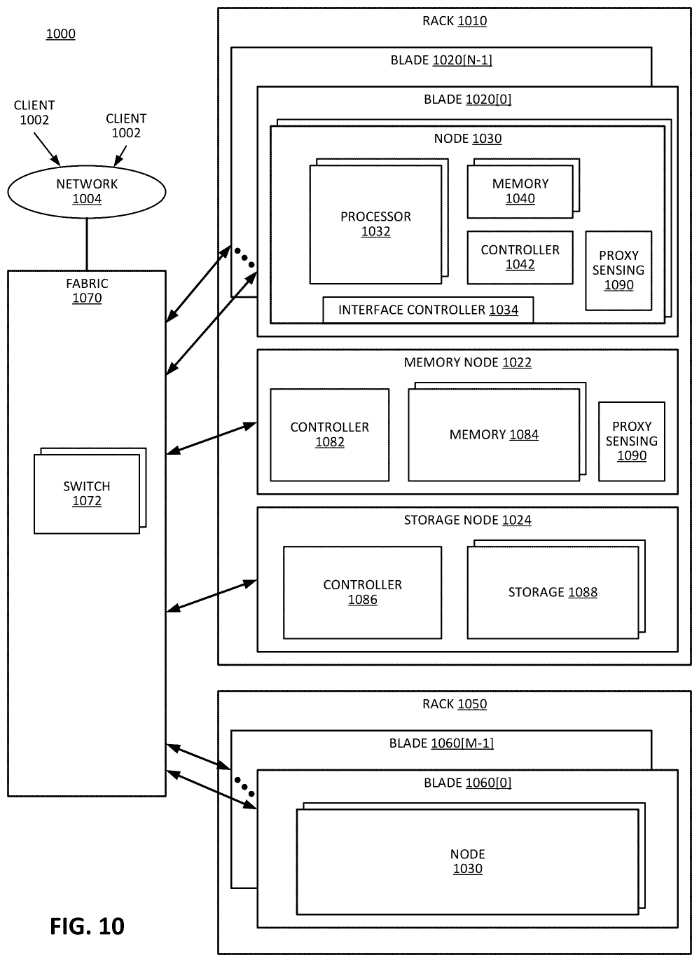

FIG. 10 is a block diagram of an example of a multi-node network in which passing sensing information by proxy can be implemented. In one example, system 1000 represents a data center. In one example, system 1000 represents a server farm. In one example, system 1000 represents a data cloud or a processing cloud.

Nodes 1030 of system 1000 represent a system in accordance with an example of system 100, system 200, system 300, or system 400. In one example, memory 1040 includes memory die stacks. In one example, memory 1084 includes memory die stacks. The stacks include a proxy die in accordance with any example herein, which can be memory die or a buffer device (not specifically illustrated). Proxy sensing 1090 represents proxy operation in accordance with any example herein.

One or more clients 1002 make requests over network 1004 to system 1000. Network 1004 represents one or more local networks, or wide area networks, or a combination. Clients 1002 can be human or machine clients, which generate requests for the execution of operations by system 1000. System 1000 executes applications or data computation tasks requested by clients 1002.

In one example, system 1000 includes one or more racks, which represent structural and interconnect resources to house and interconnect multiple computation nodes. In one example, rack 1010 includes multiple nodes 1030. In one example, rack 1010 hosts multiple blade components, blade 1020 [0], . . . , blade 1020 [N−1], collectively blades 1020. Hosting refers to providing power, structural or mechanical support, and interconnection. Blades 1020 can refer to computing resources on PCBs (printed circuit boards), where a PCB houses the hardware components for one or more nodes 1030. In one example, blades 1020 do not include a chassis or housing or other “box” other than that provided by rack 1010. In one example, blades 1020 include housing with exposed connector to connect into rack 1010. In one example, system 1000 does not include rack 1010, and each blade 1020 includes a chassis or housing that can stack or otherwise reside in close proximity to other blades and allow interconnection of nodes 1030.

System 1000 includes fabric 1070, which represents one or more interconnectors for nodes 1030. In one example, fabric 1070 includes multiple switches 1072 or routers or other hardware to route signals among nodes 1030. Additionally, fabric 1070 can couple system 1000 to network 1004 for access by clients 1002. In addition to routing equipment, fabric 1070 can be considered to include the cables or ports or other hardware equipment to couple nodes 1030 together. In one example, fabric 1070 has one or more associated protocols to manage the routing of signals through system 1000. In one example, the protocol or protocols is at least partly dependent on the hardware equipment used in system 1000.

As illustrated, rack 1010 includes N blades 1020. In one example, in addition to rack 1010, system 1000 includes rack 1050. As illustrated, rack 1050 includes M blade components, blade 1060 [0], . . . , blade 1060 [M−1], collectively blades 1060. M is not necessarily the same as N; thus, it will be understood that various different hardware equipment components could be used, and coupled together into system 1000 over fabric 1070. Blades 1060 can be the same or similar to blades 1020. Nodes 1030 can be any type of node and are not necessarily all the same type of node. System 1000 is not limited to being homogenous, nor is it limited to not being homogenous.

The nodes in system 1000 can include compute nodes, memory nodes, storage nodes, accelerator nodes, or other nodes. Rack 1010 is represented with memory node 1022 and storage node 1024, which represent shared system memory resources, and shared persistent storage, respectively. One or more nodes of rack 1050 can be a memory node or a storage node.

Nodes 1030 represent examples of compute nodes. For simplicity, only the compute node in blade 1020 [0] is illustrated in detail. However, other nodes in system 1000 can be the same or similar. At least some nodes 1030 are computation nodes, with processor (proc) 1032 and memory 1040. A computation node refers to a node with processing resources (e.g., one or more processors) that executes an operating system and can receive and process one or more tasks. In one example, at least some nodes 1030 are server nodes with a server as processing resources represented by processor 1032 and memory 1040.

Memory node 1022 represents an example of a memory node, with system memory external to the compute nodes. Memory nodes can include controller 1082, which represents a processor on the node to manage access to the memory. The memory nodes include memory 1084 as memory resources to be shared among multiple compute nodes.

Storage node 1024 represents an example of a storage server, which refers to a node with more storage resources than a computation node, and rather than having processors for the execution of tasks, a storage server includes processing resources to manage access to the storage nodes within the storage server. Storage nodes can include controller 1086 to manage access to storage 1088 of the storage node.

In one example, node 1030 includes interface controller 1034, which represents logic to control access by node 1030 to fabric 1070. The logic can include hardware resources to interconnect to the physical interconnection hardware. The logic can include software or firmware logic to manage the interconnection. In one example, interface controller 1034 is or includes a host fabric interface, which can be a fabric interface in accordance with any example described herein. The interface controllers for memory node 1022 and storage node 1024 are not explicitly shown.

Processor 1032 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory 1040 can be or include memory devices represented by memory 1040 and a memory controller represented by controller 1042.

In general with respect to the descriptions herein, in one aspect a memory die includes: a sensor to generate first sensing data for a first memory die in a memory die stack; a hardware interface to a management communication bus; and logic to receive second sensing data from a second memory die in the memory die stack and provide the first sensing data and the second sensing data to a memory controller through the management communication bus.

In accordance with one example of the memory die, the logic is to store the first sensing data and the second sensing data in a mode register. In accordance with any preceding example of the memory die, in one example, the logic is to send the first sensing data and the second sensing data to the memory controller. In accordance with any preceding example of the memory die, in one example, the logic is to send the first sensing data and the second sensing data to the memory controller through a buffer device. In accordance with any preceding example of the memory die, in one example, the logic includes circuitry in the first memory die. In accordance with any preceding example of the memory die, in one example, the logic includes circuitry in a base die of the memory die stack. In accordance with any preceding example of the memory die, in one example, the sensor includes a first sensor, and further including a second sensor on the second memory die to generate the second sensing data.

In general with respect to the descriptions herein, in one aspect a memory controller includes: a first hardware interface to a data bus connected to a memory die stack having a first memory die and a second memory die, the memory die stack including proxy logic to receive first sensing data from the first memory die and second sensing data from the second memory die; a second hardware interface to couple to a management communication bus, the second hardware interface to receive the first sensing data and the second sensing data from the proxy logic; and refresh control logic to adjust refresh management of the memory die stack based on the first sensing data and the second sensing data received from the proxy logic.

In accordance with one example of the memory die, the proxy logic is to store the first sensing data and the second sensing data in a mode register. In accordance with any preceding example of the memory controller, in one example, the memory die stack further includes a buffer device, wherein the proxy logic is to send the first sensing data and the second sensing data to the memory controller through the buffer device. In accordance with any preceding example of the memory controller, in one example, the proxy logic includes circuitry in the first memory die. In accordance with any preceding example of the memory controller, in one example, the proxy logic includes circuitry in a base die of the memory die stack.

In general with respect to the descriptions herein, in one aspect a system includes: a memory controller; and a memory die stack including: a first memory die having a first sensor to generate first sensing data for the first memory die; a second memory die having a second sensor to generate second sensing data for the second memory die; and proxy logic to receive the first sensing data and the second sensing data, the proxy logic to send the first sensing data and the second sensing data to the memory controller over a management communication bus.

In accordance with one example of the system, the proxy logic is to store the first sensing data and the second sensing data in a mode register. In accordance with any preceding example of the system, in one example, the proxy logic is to send the first sensing data and the second sensing data to the memory controller. In accordance with any preceding example of the system, in one example, the proxy logic is to send the first sensing data and the second sensing data to the memory controller through a buffer device. In accordance with any preceding example of the system, in one example, the proxy logic includes circuitry in the first memory die. In accordance with any preceding example of the system, in one example, the proxy logic includes circuitry in a base die of the memory die stack. In accordance with any preceding example of the system, in one example, the system includes a host processor coupled to the memory controller. In accordance with any preceding example of the system, in one example, the system includes a display communicatively coupled to a host processor. In accordance with any preceding example of the system, in one example, the system includes a network interface communicatively coupled to a host processor. In accordance with any preceding example of the system, in one example, the system includes a battery to power the system.

Flow diagrams as illustrated herein provide examples of sequences of various process actions. The flow diagrams can indicate operations to be executed by a software or firmware routine, as well as physical operations. A flow diagram can illustrate an example of the implementation of states of an FSM (finite state machine), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., ROM (read only memory), RAM (random access memory), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, ASICs (application specific integrated circuits), DSPs (digital signal processors), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A memory die comprising:
a sensor to generate first sensing data for a first memory die in a memory die stack;
a hardware interface to a management communication bus; and
logic to receive second sensing data from a second memory die in the memory die stack and provide the first sensing data and the second sensing data to a memory controller through the management communication bus.

2. The memory die of claim 1, wherein the logic is to store the first sensing data and the second sensing data in a mode register.

3. The memory die of claim 1, wherein the logic is to send the first sensing data and the second sensing data to the memory controller.

4. The memory die of claim 3, wherein the logic is to send the first sensing data and the second sensing data to the memory controller through a buffer device.

5. The memory die of claim 1, wherein the logic comprises circuitry in the first memory die.

6. The memory die of claim 1, wherein the logic comprises circuitry in a base die of the memory die stack.

7. The memory die of claim 1, wherein the sensor comprises a first sensor, and further comprising a second sensor on the second memory die to generate the second sensing data.

8. A memory controller comprising:
a first hardware interface to a data bus connected to a memory die stack having a first memory die and a second memory die, the memory die stack including proxy logic to receive first sensing data from the first memory die and second sensing data from the second memory die;
a second hardware interface to couple to a management communication bus, the second hardware interface to receive the first sensing data and the second sensing data from the proxy logic; and
refresh control logic to adjust refresh management of the memory die stack based on the first sensing data and the second sensing data received from the proxy logic.

9. The memory controller of claim 8, wherein the proxy logic is to store the first sensing data and the second sensing data in a mode register.

10. The memory controller of claim 8, wherein the memory die stack further comprises a buffer device, wherein the proxy logic is to send the first sensing data and the second sensing data to the memory controller through the buffer device.

11. The memory controller of claim 8, wherein the proxy logic comprises circuitry in the first memory die.

12. The memory controller of claim 8, wherein the proxy logic comprises circuitry in a base die of the memory die stack.

13. A system comprising:
a memory controller; and
a memory die stack including:
a first memory die having a first sensor to generate first sensing data for the first memory die;
a second memory die having a second sensor to generate second sensing data for the second memory die; and
proxy logic to receive the first sensing data and the second sensing data, the proxy logic to send the first sensing data and the second sensing data to the memory controller over a management communication bus.

14. The system of claim 13, wherein the proxy logic is to store the first sensing data and the second sensing data in a mode register.

15. The system of claim 13, wherein the proxy logic is to send the first sensing data and the second sensing data to the memory controller.

16. The system of claim 15, wherein the proxy logic is to send the first sensing data and the second sensing data to the memory controller through a buffer device.

17. The system of claim 13, wherein the proxy logic comprises circuitry in the first memory die.

18. The system of claim 13, wherein the proxy logic comprises circuitry in a base die of the memory die stack.

19. The system of claim 13, including one or more of:
a host processor coupled to the memory controller;
a display communicatively coupled to a host processor;
a network interface communicatively coupled to a host processor; or
a battery to power the system.
